(19) United States
(12) Patent Application Publication
(10) Pub. No.: US 2011/0298857 A1
(43) Pub. Date: Dec. 8, 2011

(54) Image Processing Apparatus And Program

(75) Inventor: Yoichiro Maki, Nagano-ken (JP)

(73) Assignee: SEIKO EPSON CORPORATION, Tokyo (JP)

(21) Appl. No.: 13/154,110

(22) Filed: Jun. 6, 2011

(30) Foreign Application Priority Data
Jun. 8, 2010 (JP) 2010-130732

(51) Int. Cl. B41J 2/205

(52) U.S. Cl. 347/15

(57) ABSTRACT

Nozzles 32C, 32M, and 32Y able to discharge color ink are formed at a first resolution, that is, 120 dpi, and nozzles 32K1 and 32K2 able to discharge black ink are formed at a second resolution, that is, 360 dpi. In addition, the printing resolution of color image data in the vertical direction is the second resolution. In this case, since pixels where the x-coordinate is 1, 4, 7 . . . , 3*n+1 (where n is an integer equal to or greater than 0) are in positions corresponding to the nozzles 32C, 32M, 32Y, and 32K1, these are transmitted to an image forming apparatus as color image data, and since the other pixels are in positions corresponding to the nozzles 32K2, these are color converted into grayscale image data and transmitted to the image forming apparatus.

The entire disclosure of Japanese Patent Application No. 2010-130732, filed Jun. 8, 2010 is expressly incorporated by reference herein.

### BACKGROUND

1. Technical Field

The present invention relates to an image processing apparatus and program.

2. Related Art

In the past, an image forming apparatus provided with a head with achromatic nozzles that discharge achromatic ink with a higher resolution than chromatic nozzles that discharge chromatic ink arranged in a paper transporting direction has been known. For example, the color ink jet recording apparatus described in JP-A-2002-301812 is provided with a head with black ink nozzles formed with double the resolution of color ink nozzles. In this color ink jet recording apparatus, when printing text data at high quality, printing for one pass is performed by moving the head in a paper feeding direction by one half of the nozzle pitch after performing printing for one pass with the black ink nozzles. In so doing, printing is performed at double the resolution of the black ink nozzles. Further, when printing text data in a draft mode, unlike in high quality printing, printing is performed at the resolution of the black ink nozzles without performing the movement by one half of the nozzle pitch. In so doing, in high quality printing, printing is possible at double the resolution of the black ink nozzles of the draft mode, while printing is possible at double the speed of high quality printing in the draft mode. On the other hand, when performing printing for color image data, printing for one pass is performed by always performing paper feeding by one half of the nozzle pitch after performing printing for one pass with the color ink nozzles. In so doing, printing is performed at double the resolution of color ink nozzles (=resolution of the black ink nozzles).

Here, there is demand to also perform high-speed image formation using a draft mode for color image data. However, with an image forming apparatus provided with a head with achromatic nozzles with a higher resolution than chromatic nozzles arranged in the paper transporting direction, the resolution of chromatic nozzles is low from the outset. For this reason, in the draft mode, that is, if image formation is performed without forming dots in the gaps in the paper transporting direction of dots formed with one pass, there is a problem in that intervals in the paper transporting direction of the dots from the chromatic nozzles widen and that visual characteristics of the formed color image tend to deteriorate.

### SUMMARY

An advantage of some aspects of the invention is that image data that is able to improve the visibility of a color image when the draft mode is used is provided to an image forming apparatus.

Aspects of the invention adopt the following in order to achieve the advantage described above.

An image processing apparatus according to an aspect of the invention connected to an image forming apparatus includes a head that includes a chromatic nozzle row that is chromatic nozzles that discharge chromatic ink lined up in a paper transporting direction at a first resolution, a first achromatic nozzle row that is first achromatic nozzles that discharge achromatic ink lined up with the chromatic nozzle row in order for positions in the transporting direction to be aligned at the first resolution, and a second achromatic nozzle row that is second achromatic nozzles that discharge achromatic ink lined up in order for gaps between the first achromatic nozzles in the transporting direction to be equal parts of A (where A is an integer equal to or greater than 2), a head moving section that moves the head in a main scanning direction that is substantially orthogonal to the paper transporting direction, and a paper feeding section that moves the paper in the transporting direction, wherein an image is able to be formed on the paper by discharging the ink from the head, the image processing apparatus including: a color image data obtaining section that lines up a plurality of pixels in the vertical direction that corresponds to the paper transporting direction at a second resolution that is the first resolution multiplied by A, while obtaining color image data composed of pixels in a matrix form that is a plurality of pixels lined up in the horizontal direction corresponding to the main scanning direction; a converted image data generation section that generates converted image data where gradation values of pixels other than pixels that have been arranged corresponding to the first resolution in the vertical direction, out of each of the pixels of the color image data, are color converted to grayscale gradation values; and a transmitting section that transmits the converted image data to the image forming apparatus.

This image processing apparatus includes a head, a head moving section that moves the head in the main scanning direction that is substantially orthogonal to the paper transporting direction, and a paper feeding section that moves the paper in the transporting direction, and is connected to an image forming apparatus that can form an image on the paper by discharging ink from the head. Further, the head of this image forming apparatus includes a chromatic nozzle row that is chromatic nozzles that discharge chromatic ink lined up in the paper transporting direction at the first resolution, a first achromatic nozzle row that is first achromatic nozzles that discharge achromatic ink lined up with the chromatic nozzle row in order for positions in the transporting direction to be aligned at the first resolution, and a second achromatic nozzle row that is second achromatic nozzles that discharge achromatic ink lined up in order for gaps between the first achromatic nozzles in the transporting direction to be equal parts of A (where A is an integer equal to or greater than 2). In addition, this image processing apparatus lines up a plurality of pixels in the vertical direction that corresponds to the paper transporting direction at the second resolution that is the first resolution multiplied by A, while obtaining color image data composed of pixels in a matrix form that is a plurality of pixels lined up in the horizontal direction corresponding to the main scanning direction. Next, converted image data where gradation values of pixels other than pixels that have been arranged corresponding to the first resolution in the vertical direction, out of each of the pixels of the color image data, are color converted to grayscale gradation values is generated, and the converted image data is transmitted to the image forming apparatus. In so doing, the converted image data becomes the pixels other than the pixels arranged in correspondence with the first resolution in the vertical direction, that is, the pixels corresponding to the positions of the second achromatic nozzles of the image forming apparatus, converted into grayscale pixels. For this reason, in a case where this image forming apparatus performs image formation of converted image data in the draft mode, while the head moving section moves the head in the main scanning direction once (one pass), by discharging ink from the nozzles of the chromatic nozzle row and the first achromatic nozzle row, an image (color image) can be formed based on the gradation values of pixels arranged corresponding to the first resolution in the vertical direction out of the converted image data. In addition, by discharging ink from the nozzles of the second achromatic nozzle row, it is also possible to form an image (grayscale image) based on the gradation values of pixels other than pixels that have been arranged corresponding to the first resolution. In so doing, since dots of the second achromatic nozzles are formed on portions that had, in the past, become gaps in the paper transporting direction of the dots formed by the chromatic nozzles in the draft mode, the visibility of a color image formed on paper is improved. Here, since there is no need to form an image based on the gradation values of pixels other than pixels that have been arranged corresponding to the first resolution by ink discharged from the chromatic nozzles and the first achromatic nozzles, that is, there is no need to perform an action such as image formation for one pass by transporting the paper for only 1/A of the nozzle pitch of the chromatic nozzles and the first achromatic nozzles, the speed of image formation does not differ from the draft mode of the past. In this manner, the image processing apparatus according to an aspect of the invention is able to provide image data (converted image data) that can improve the visibility of a color image during the draft mode to the image forming apparatus. Here, “grayscale” is an image (pixels) expressed by only the lightness between white and black, and is intended to also include those expressed by two gradations (only black and white).

In the image processing apparatus according to an aspect of the invention, the converted image data generation section derives the saturation and brightness of pixels from the gradation values of the pixels that are the subjects of the color conversion, corrects the brightness of the pixels that are the subjects of the color conversion to a high brightness corresponding to the level of the derived saturation, and may make the grayscale gradation values obtained by reflecting the post-correction brightness the gradation values of the post-color conversion pixels. Here, in a case where the gradation values of color pixels are color converted to grayscale gradation values, particularly with pixels at high saturation, the post-color conversion pixels tend to be displayed dark, and there is a case where the color reproducibility of an image formed on paper is lowered. In this image processing apparatus, since the brightness of pixels is corrected to a high brightness corresponding to the level of the saturation of the image and the grayscale gradation values obtained by reflecting the post-correction brightness are made to be the gradation values of the post-color conversion pixels, the post-color conversion pixels of pixels of high saturation are made bright and the color reproducibility is improved.

In the image processing apparatus according to an aspect of the invention that performs correction of the brightness as described above, an edge detection section that detects edge pixels that correspond to the edge portions of the color image data is provided, the converted image data generation section makes, out of the pixels that are the subjects of the color conversion, with regard to the edge pixels, the grayscale gradation values obtained by reflecting the derived brightness by deriving the brightness of pixels from the gradation values of the pixels that are the subjects of the color conversion the gradation values of the post-color conversion pixels, and with regard to the pixels other than the edge pixels, the grayscale gradation values obtained by deriving the saturation and brightness of pixels from the gradation values of the pixels that are the subjects of the color conversion, correcting the brightness of the pixels that are the subjects of the color conversion to a high brightness corresponding to the level of the derived saturation, and reflecting the post-correction brightness may be made to be the gradation values of the post-color conversion pixels. In so doing, it is possible to improve the color reproducibility of the pixels other than the edge pixels while preventing deterioration in the visibility of the edge pixels. That is, if the correction of the brightness is performed as described above, whereas there is a case when, particularly with regard to edge pixels corresponding to the edge portions of an image, visibility is reduced compared to a case when correction of the brightness is not performed, this can be prevented. The image processing apparatus according to this embodiment of the invention may be provided with an edge emphasis section that performs edge emphasis processing on edge pixels detected by the edge detection section out of the color image data, the converted image data generation section may generate, out of the color image data on which the edge emphasis processing has been performed, converted image data that is the gradation values of the pixels other than the pixels arranged in correspondence with the first resolution in the vertical direction color converted to grayscale gradation values, the converted image data generation section may make, out of the pixels that are the subjects of the color conversion, with regard to the edge pixels, the grayscale gradation values obtained by deriving the brightness of the pixels from the gradation values of the pixels that are the subjects of the color conversion and reflecting the derived brightness the gradation values of the post-color conversion pixels, and with regard to the pixels other than the edge pixels, may make the grayscale gradation values obtained by deriving the saturation and brightness of the pixels from the gradation values of the pixels that are the subjects of the color conversion, correcting the brightness of the pixels that are the subjects of the color conversion to a high brightness corresponding to the level of the derived saturation, and reflecting the post-correction brightness the gradation values of the post-color conversion pixels. In so doing, while preventing deterioration in visibility with regard to the edge pixels by performing emphasis processing and not performing correction of the brightness, color reproducibility is improved with regard to the pixels other than the edge pixels by performing correction of the brightness.

A program according to an aspect of the invention is for making a computer function as any one of the image processing apparatuses described above. This program may be recorded on a computer-readable recording medium (for example, a hard disk, ROM, FD, CD, DVD, or the like), may be transmitted from one computer to another computer via a transmission medium (a communication network such as the Internet or a LAN), or may be exchanged by any other means. If this program is executed by a computer, since the computer functions as an image processing apparatus according to an aspect of the invention as described above, the same operational effects as those of the image processing apparatus according to as aspect of the invention are obtained.

### BRIEF DESCRIPTION OF THE DRAWINGS

The invention will be described with reference to the accompanying drawings, wherein like numbers reference like elements.

FIG. 1 is a configuration diagram illustrating an outline of the configuration of an ink jet printer.

FIG. 2 is a configuration diagram illustrating an outline of the configuration of a printing head.

FIG. 3 is a flowchart illustrating an example of a draft printing routine.

FIG. 4 is an explanatory diagram illustrating the relationship between the positions of pixels and the position of each nozzle of the printing head.

FIG. 5 is a flowchart illustrating an example of CMYK color conversion processing.

FIG. 6 is an explanatory diagram of a generation rate derivation table.

FIG. 7 is an explanatory diagram showing the state of turning dots on and off using a dither matrix.

FIG. 8 is a flowchart illustrating an example of grayscale color conversion processing.

FIG. 9 is an explanatory diagram showing a state of deriving a corrected brightness Y′.

FIG. 10 is an explanatory diagram illustrating a state of performing printing by a draft printing routine.

FIG. 11 is an explanatory diagram showing a state of printing by a different example draft mode.

### DESCRIPTION OF EXEMPLARY EMBODIMENTS

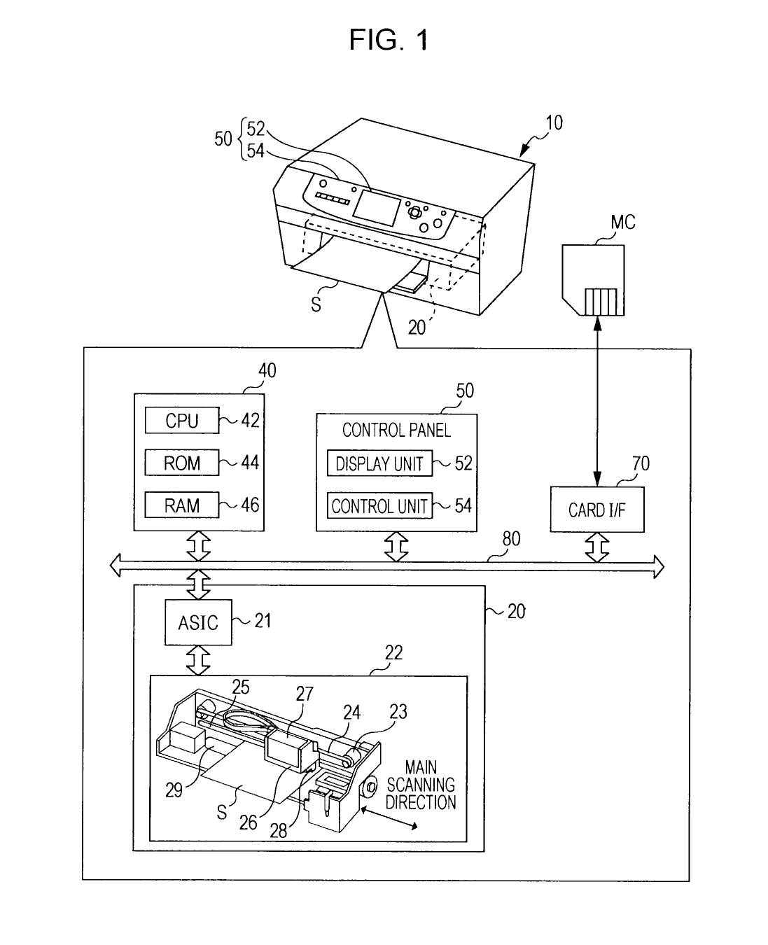

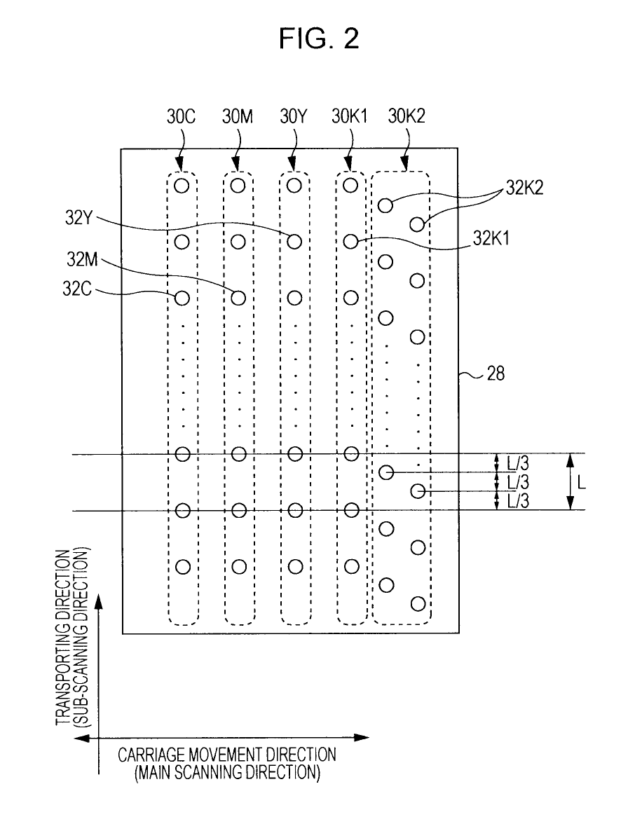

Next, embodiments of the invention will be described using the drawings. FIG. 1 is a configuration diagram illustrating an outline of the configuration of an ink jet printer 10, and FIG. 2 is a configuration diagram illustrating an outline of the configuration of a printing head 28. The ink jet printer 10 of the embodiment is provided with, as shown in FIG. 1, a printer unit 20 that prints an image on paper S, a controller 40 that executes various processes, a operation panel 50 that can display information to a user and into which an instruction from the user can be input, and a card interface (I/F) 70 that is a mobile recording medium and that is used to connect to a memory card MC on which image data is saved. The likes of the controller 40, the operation panel 50, and the card I/F 70 are electrically connected by a bus 80.

The printer unit 20 is provided with an ASIC 21 and a printer mechanism 22. The ASIC 21 is an integrated circuit that controls the printer mechanism 22, and controls the printer mechanism 22 to print an image on the paper S, based on the image data that is the subject of the print command, when a print command is received from the controller 40. The printer mechanism 22 is provided with a carriage 26 that is driven by a belt 24 that is suspended in a looped form with a carriage motor 23 in the left and right direction (main scanning direction) and that reciprocally moves left and right along a guide 25, ink cartridges 27 that are installed on the carriage 26 and that separately store ink of each color of cyan (C), magenta (M), yellow (Y), and black (K) (hereinafter, referred to as C, M, Y, and K as appropriate), the printing head 28 that applies pressure to each ink supplied by each ink cartridge 27 and discharges ink toward the paper S, and a transporting roller 29 that feeds the paper S supplied from the rear side out to the front side. As shown in FIG. 2, in the printing head 28 are formed nozzles 32C, 32M, and 32Y that can separately discharge ink of each of the colors of CMY as nozzle rows 30C, 30M, and 30Y arranged in the transporting direction (a sub-scanning direction) of the paper S, and nozzles 32K that can discharge black (K) ink as nozzle rows 30K1 and 30K2 arranged in the sub-scanning direction. The nozzle row 30C is nozzles 32C lined up in order for the pitch to be a predetermined length L. The nozzle rows 30M, 30Y, and 30K1 are likewise nozzles 32M, 32Y, and 32K1 lined up in order for the pitch to be a predetermined length L. In the embodiment, the predetermined length L is set in order for the resolution of the dots in the transporting direction to be 120 dpi. Further, the nozzles 32C, 32M, 32Y, and 32K1 are the same number, and are formed in order for the positions of the nozzles 32M, 32Y, and 32K1 to be aligned in the transporting direction. The nozzle row 30K2 is nozzles 32K2 lined up in order for the gaps (length L) of the nozzles 32K1 of the nozzle row 30K1 in the transporting direction to be divided into 3 equal parts. Further, the number of nozzles 32K2 is twice the number of nozzles 32K1, and the nozzles 32K2 are arranged in a zigzag pattern along the sub-scanning direction. In so doing, in a case where K ink is discharged from both of the nozzles 32K1 and the nozzles 32K2, the resolution of the K dots in the transporting direction is 360 dpi that is three times 120 dpi. In this manner, the printing head 28 is configured in order for the resolution of the CMY dots to be 120 dpi and for the resolution of the K dots to be 360 dpi. That is, the nozzle density of K is high compared to the nozzle density of CMY. Hereinafter, 120 dpi may be referred to as the first resolution, and 360 dpi may be referred to as the second resolution. Further, the printing head 28 applies a voltage to piezoelectric elements provided for each nozzle and deforms the nozzles. In so doing, large, medium, and small dots can be formed on the paper S by discharging pressurized ink. The differentiation of the large, medium, and small dots is performed by adjusting the waveform of the voltage applied to the piezoelectric elements.

The operation panel 50 is a device for a user to input various instructions to the ink jet printer 10, and is provided with a display unit 52 configured by a color liquid crystal panel on which images and characters corresponding to various instructions are displayed, and an operation unit 54 on which cursor keys and a confirm key that a user presses when performing various operations are arranged. Here, when a user operates the operation unit 54 and instructs printing, a draft mode stressing printing speed and a high quality mode stressing printing quality can be selected.

The card I/F 70 is a device for writing data into the memory card MC, reading data from the memory card MC, and the like. The memory card MC is a nonvolatile memory in which data can be written in or deleted, and has a plurality of, for example, items of color image data captured by a capturing apparatus such as a digital camera, or items of color image data including images and text of diagrams and photographs recorded therein. In the embodiment, such color image data is configured with the pixels shown in RGB color space lined up in a matrix form, and the RGB value of each pixel data is each shown by gradation values of 0 to 255 (8 bits) according to the shade of RGB. Here, the value 0 represents the deepest color, and the value 255 represents the palest color.

The controller 40 is configured as a microprocessor centered around a CPU 42, and is provided with a ROM 44 with various processing programs, various data, and various tables recorded thereon, and a RAM 46 that temporarily stores printing data and the like. This controller 40 inputs various movement signals and various detection signals from the printer unit 20 or the card I/F 70, inputs control signals generated in accordance with controls of the operation unit 54 of the operation panel 50, and the like. Further, the controller 40 outputs reading commands to the card I/F 70 for reading data from the memory card MC and outputting to the controller 40, outputs print commands to the printer unit 20 to perform printing of image data, outputs control commands for the display unit 52 to the operation panel 50, and the like.

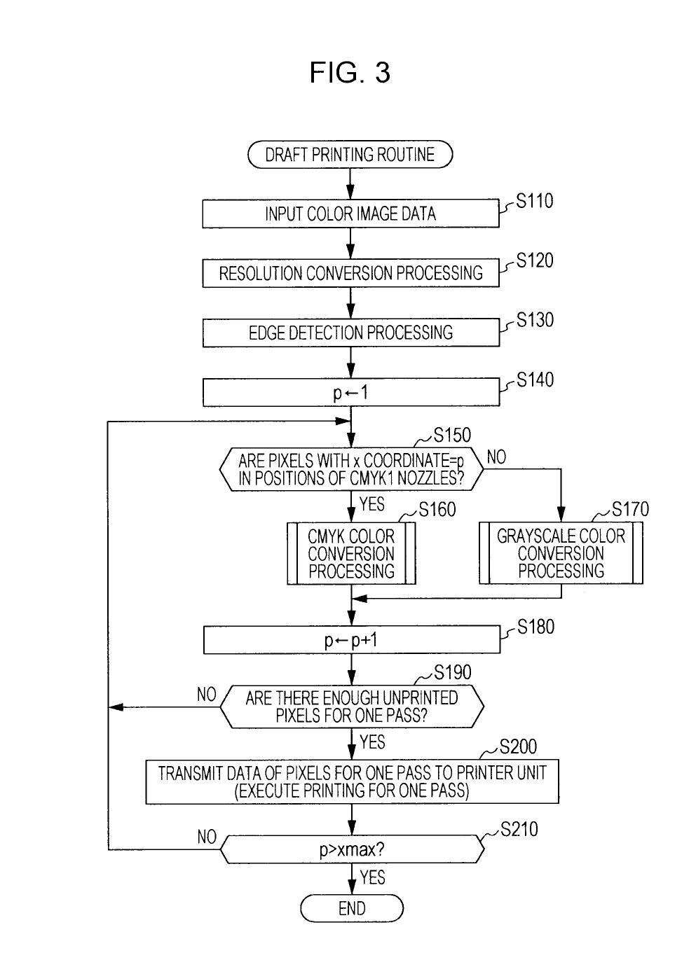

Next, the movements of the ink jet printer 10 of the embodiment configured as described above, and in particular, the movements in a case when draft printing is performed where color image data recorded on the memory card MC is printed on the paper S in the draft mode will be described. FIG. 3 is a flowchart illustrating an example of a draft printing routine executed by the controller 40. This routine is executed when the user selects the color image data recorded on the memory card MC and instructs for the selected image data to be printed in the draft mode via the operation panel 50.

When the print processing routine is started in FIG. 3, the controller 40 first inputs the color image data which has been instructed to be printed by the user via the operation panel 50 (Step S110), and converts the resolution of the input color image data to the printing resolution for when the image is printed on the paper S (Step S120). Specifically, the resolution is converted in order for the resolution of the direction (hereinafter, the vertical direction) corresponding to the transporting direction of when the color image data is printed on the paper S to be the second resolution, and for the resolution of the direction (hereinafter, the horizontal direction) corresponding to the main scanning direction of when the color image data is printed on the paper S to be the second resolution. Here, as long as the resolution of the horizontal direction is a resolution at which the printing head 28 is able to form dots on the paper S, the resolution may be other than the second resolution, such as, for example, 720 dpi. The conversion of the resolution is performed, for example, when the resolution of the color image data input in Step S110 is lower than the printing resolution, by newly generating pixels through interpolation (for example, copying) between neighboring color image data. Further, when the resolution of the input image data is higher than the printing resolution, conversion is performed by thinning out pixels at a constant rate. In this manner, in Step S120, interpolation and thinning out of input color data are performed as appropriate. Here, the positions of the pixels of the color image data are shown in the coordinates (x, y) where the vertical direction is the x direction and the horizontal direction is the y direction. Further, the post-conversion color image data to the printing resolution has xmax pixels vertically and ymax pixels horizontally arranged in a matrix form.

Next, the controller 40 performs edge detection processing to determine whether or not each pixel of the color image data obtained by the resolution conversion in Step S120 is an edge pixel that corresponds to the edge portion of the color image data (Step S130). The edge detection processing can be performed by, for example, deriving the brightness of 9 pixels in all directions centered around a target pixel from the grayscale of RGB of each pixels, calculating the edge strength using the derived brightness and a Sobel filter, and comparing the edge strength with a threshold value. Here, edge detection processing may be performed using other filters such as a Prewitt filter. Here, the CPU 42 records the results of the edge detection processing (which pixels are the edge pixels) in the RAM 46.

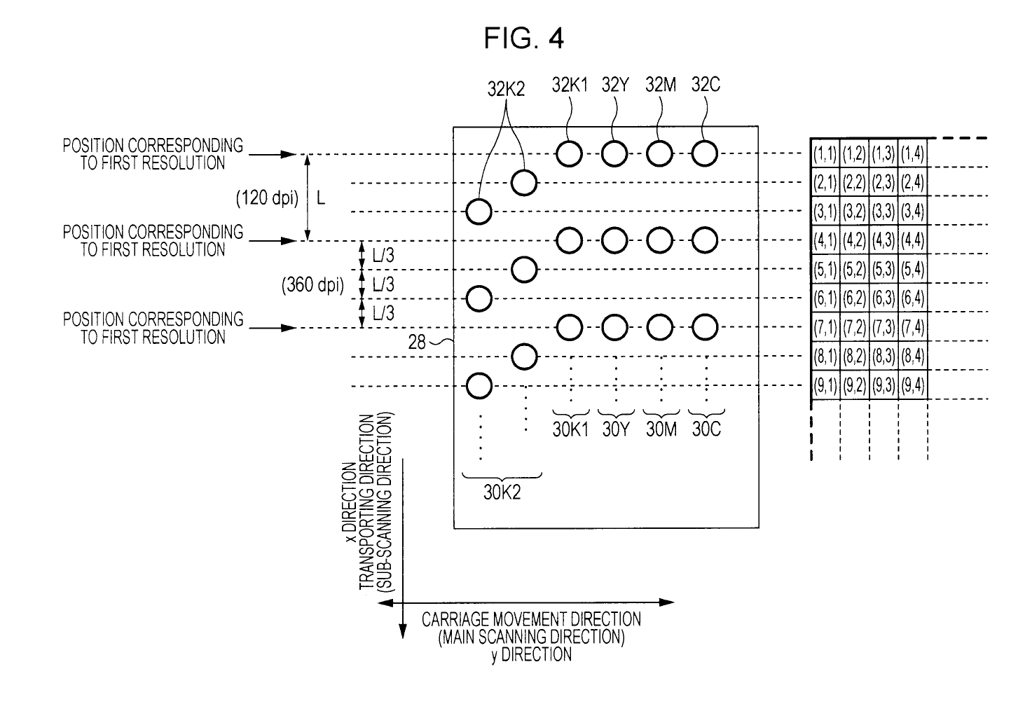

Next, a pointer p is initialized to the value 1 (Step S140), and it is determined whether or not the pixels where the x-coordinate is the value p are pixels in positions that correspond to the nozzles 32C, 32M, 32Y, and 32K1 (Step S150). The relationship between the positions of pixels and the position of each nozzle of the printing head 28 is illustrated in FIG. 4. As described above, in the embodiment, the nozzles 32C, 32M, 32Y, and 32K1 are formed at the first resolution, that is, 120 dpi, and the printing resolution in the vertical direction of the color image data is the second resolution, that is, 360 dpi (three times the first resolution). For this reason, pixels where the x-coordinate is 1, 4, 7 . . . , 3*n+1 (where n is an integer equal to or greater than 0) are in positions corresponding to the nozzles 32C, 32M, 32Y, and 32K1 (positions corresponding to the first resolution), and other pixels are in positions corresponding to the nozzles 32K2. Therefore, in Step S150, there is affirmative determination when the value p is 1, 4, 7 . . . , 3*n+1, and there is negative determination at all other times.

In addition, if there is affirmative determination in Step S150, the controller 40 executes CMYK color conversion processing for color converting pixels where the x-coordinate is the value p from RGB to CMYK (Step S160), and if there is negative determination in Step S150, the controller 40 executes grayscale color conversion processing for color converting pixels where the x-coordinate is the value p from RGB to K (grayscale) (Step S170).

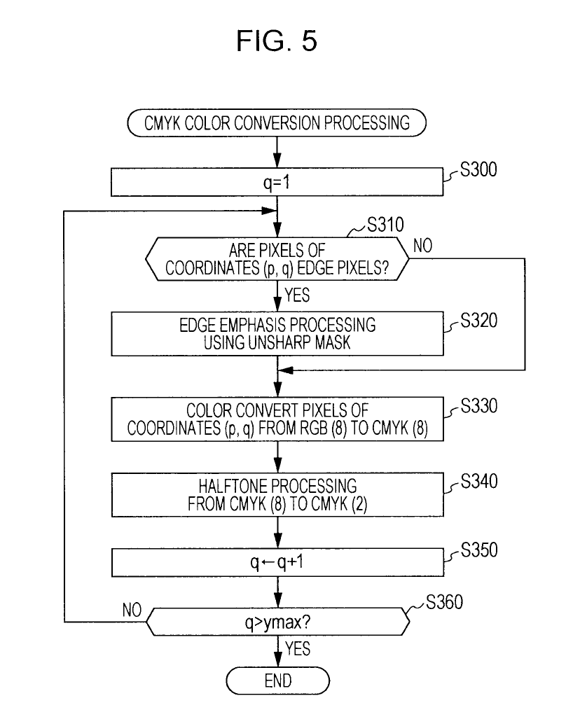

Here, description of the draft printing routine will be deferred, and the CMYK color conversion processing of Step S160 and the grayscale color conversion processing of Step S170 will be described. First, the CMYK color conversion processing will be described. FIG. 5 is a flowchart illustrating an example of CMYK color conversion processing. Here, the numerical values inside ( ) in the diagram indicate the number of bits in a pixel. In this CMYK color conversion processing, the controller 40 first initializes a pointer q to the value 1 (Step S300) and examines whether the coordinates (p, q) indicate an edge pixel (Step S310). Whether or not this is an edge pixel is determined by reading the result of the edge detection processing of Step S130 described above from the RAM 46. Further, when there is an edge pixel, edge emphasis processing for emphasizing the pixel at the coordinates (p, q) is performed (Step S320). Edge emphasis processing can be performed using, for example, a USM (UnSharp Mask). Specifically, first, the average values R′G′B′ of each gradation value of RGB of 9 pixels in all directions centered around a pixel at the coordinates (p, q) are derived as the unsharp mask. In addition, the difference between the gradation values of RGB of the pixel at the coordinates (p, q) and each color of R′G′B′ is obtained. Further, the value obtained by adding this difference to each color of the gradation values of RGB of the pixel at the coordinates (p, q) is made to be the gradation values of post-edge emphasis RGB. In so doing, the difference in color between the edge pixels and the surrounding pixels becomes large, and become pixels with more emphasized edges.

If a negative determination is made in Step S310 or the processing of Step S320 is performed, the controller 40 generates converted image data that is the gradation values (8 bits each) of RGB of the pixel at the coordinates (p, q) color converted into the gradation values (8 bits each) of CMYK (Step S330). This color conversion is performed by referencing a 3D LUT (LookUp Table) that is the gradation values of RGB and the gradation values of CMYK that are three-dimensional input values made to be compatible. This 3D LUT is recorded in the ROM 44 in advance.

Next, the controller 40 executes halftone processing of converting each of the gradation values of CMYK of the post-color conversion pixel at the coordinates (p, q) from 8 bits to 2 bits (Step S340). These gradation values of 2 bits are set for each color of CMYK, and “00” represents no dot formation, “01” represents small dot formation, “10” represents medium dot formation, and “11” represents large dot formation. In the embodiment, a dither method is utilized for the halftone processing.

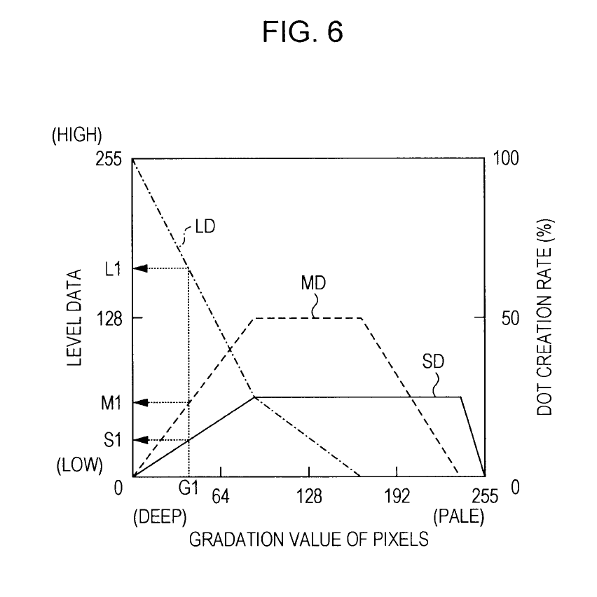

Here, halftone processing by the dither method will be described in detail. Since halftone processing can be performed similarly for each color of CMYK, the color of C will be described as a representative example. FIG. 6 is an explanatory diagram of a generation rate derivation table illustrating the correspondence relationship between the gradation values of C of before performing halftone processing and the generation rate (%) of each dot type of large, medium, and small. In this FIG. 6, the horizontal axis represents the gradation values of C (0 to 255), the vertical axis on the right side represents the dot generation rate (%), and the vertical axis on the left side represents level data (0 to 255). Here, level data is the dot generation rate converted into data of 256 levels of the values 0 to 255. In addition, the dot generation rate denotes, when a uniform region is reproduced according to a particular gradation value, the proportion of pixels where dots are formed within such a region. For example, the dot generation rate of a particular gradation value is 65% large dots, 25% medium dots, and 10% small dots, and a region of 100 pixels composed of 10 pixels in the vertical direction and 10 pixels in the horizontal direction is printed. In this case, out of the 100 pixels, there are 65 pixels where large dots are formed, 25 pixels where medium dots are formed, and 10 pixels where small dots are formed.

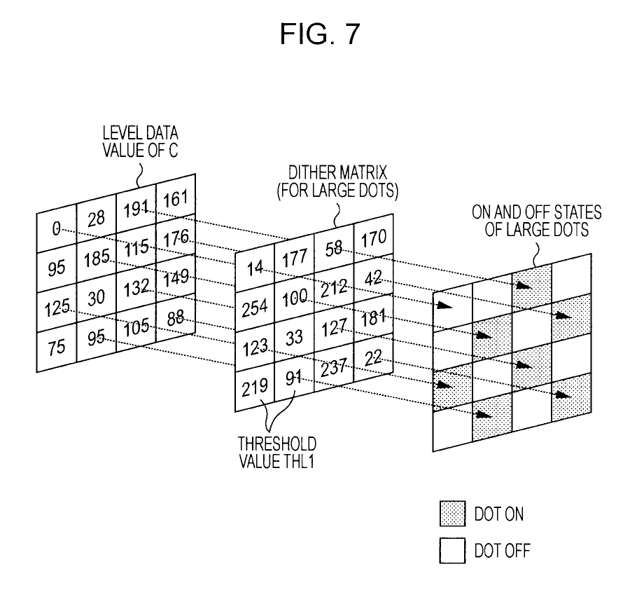

At this point, it is supposed that the gradation values of C of the pixel at the coordinates (p, q) are a value G1. In this case, if this value G1 is taken from the generation rate derivation table of FIG. 6, the level data values of large dots, medium dots, and small dots are respectively the values L1, M1, and S1. FIG. 7 is an explanatory diagram showing the state of turning dots on and off using a dither matrix of large dots. This dither matrix is set, in the embodiment, in order for the values from 0 to 254 to appear on square pixel blocks having 16×16 pixels. However, due to restrictions of the diagram, FIG. 7 is illustrated with a matrix of 4×4. In addition, a threshold value THL1 set to correspond to the position (p, q) of the pixel of this C out of the dither matrix of large dots is read, and the level data value L1 of large dots and the threshold value THL1 are compared. At this time, if the level data value L1 exceeds the threshold value THL1, the value of the 2 bits of C after halftone processing is made to be “11” in order to form (that is, to turn on) large dots. On the other hand, if the level data value L1 does not exceed the threshold value THL1, a threshold value THM1 set to correspond to the position (p, q) of the pixel of this C out of the dither matrix of medium dots (not shown) is subsequently read, and the level data value M1 of medium dots and the threshold value THM1 are compared. At this time, if the level data value M1 exceeds the threshold value THM1, the value of the 2 bits of C of after halftone processing is made to be “10” in order to form (that is, to turn on) medium dots. On the other hand, if the level data value M1 does not exceed the threshold value THM1, a threshold value THS1 set to correspond to the position (p, q) of the pixel of this C out of the dither matrix of small dots (not shown) is subsequently read, and the level data value S1 of small dots and the threshold value THS1 are compared. At this time, if the level data value S1 exceeds the threshold value THS1, the value of the 2 bits of C of after halftone processing is made to be “01” in order to form (that is, to turn on) small dots, and if the threshold value THS1 is not exceeded, the value of the 2 bits is made to be “00” in order to form no dots. In so doing, the gradation values of C are each converted from 8 to 2 bits. Further, the gradation values of M, Y, and K are similarly converted to 2 bits. Here, the generation rate derivation table and the dither matrix of each dot type are set in order for the deepness of a region formed with dots to appear deep, corresponding to how small the original gradation values (8 bits) of the pixels are, to a person observing the region. In addition, the generation rate derivation table of each color of CMYK and the dither matrix for each dot type are recorded in the ROM 44 in advance.

When the halftone processing of Step S340 is performed, the controller 40 increments the pointer q by a value 1 (Step S350), and determines whether or not the pointer q has exceeded the value ymax (Step S360). Further, if a negative determination is made, the process proceeds to Step S310, and repeats the processes of Steps S310 to S360 until affirmative determination is made in Step S360. In so doing, sequential processing is performed on pixels from the coordinates (p, 1) to (p, ymax). Further, if an affirmative determination is made in Step S360, the CMYK color conversion processing is ended.

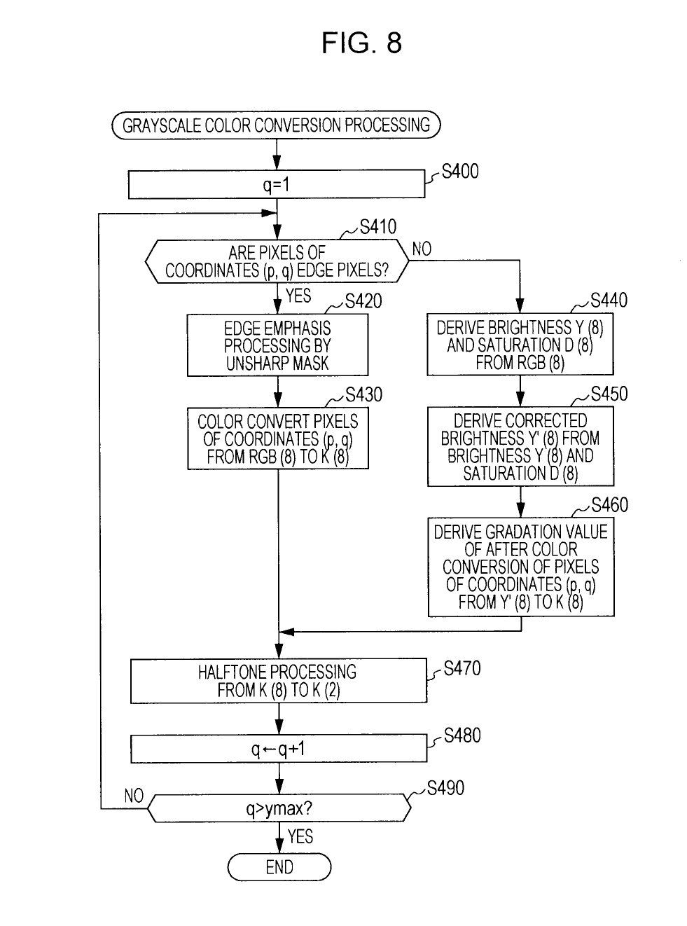

Next, the grayscale color conversion processing of Step S170 will be described. FIG. 8 is a flowchart illustrating an example of grayscale color conversion processing. Here, the numerical values inside ( ) in the diagram indicate the number of bits in a pixel. In this grayscale color conversion processing, the controller 40 first initializes the pointer q to the value 1 (Step S400), examines whether the coordinates (p, q) indicate an edge pixel (Step S410), and if there is affirmative determination, edge emphasis processing for emphasizing the pixel at the coordinates (p, q) is performed (Step S420). As the processes of these Steps S410 and S420 are the same as the processes of Steps S310 and S320 described above, detailed description thereof will be omitted. Further, if the processing of Step S420 is performed, converted image data that is the gradation values (8 bits each) of RGB of the pixel at the coordinates (p, q) color converted into the gradation values of K, that is grayscale gradation values (8 bits each), is generated (Step S430). This color conversion is performed by deriving, using the values of each gradation value of RGB of the pixel at the coordinates (p, q), the brightness Y of the pixel at the coordinates (p, q) by Equation (1) described below, and by making the value of the derived brightness Y the grayscale gradation value as is. In addition, the greater the value of the brightness Y, the higher the brightness expressed, and the greater the value of the grayscale gradation, the closer it is to white (pale). Further, the brightness Y is an integer of the values 0 to 255, and if the value derived by Equation (1) is not an integer, appropriate rounding processing is performed.

Y=(3*R+11*G+2*B)/16 (1)

On the other hand, if a negative determination is made in Step S410, the controller 40 derives the brightness Y and the saturation (color difference) D of a pixel from the gradation values of RGB of the pixel at the coordinates (p, q) (Step S440). Here, the brightness Y is derived by Equation (1) described above. Further, the saturation D is derived by Equation (2) described below. For example, if the gradation values (R, G, B) at the coordinates (p, q)=(240, 160, 0), the brightness Y is the value 155, and the saturation D is the value 240. Further, the greater the value of the saturation D, the higher the saturation expressed.

D=MAX(R,G,B)−MIN(R,G,B) (2)

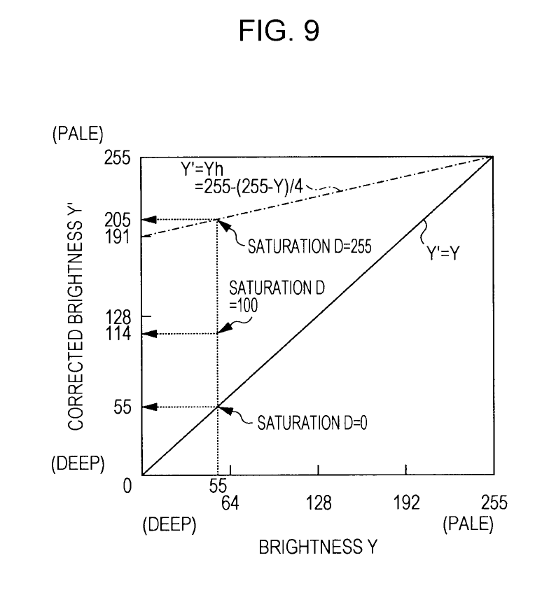

Next, the controller 40 derives a corrected brightness Y′ (8 bits) that is the brightness Y corrected to be a high brightness (=the high level of the value of the brightness Y) corresponding to the level of the saturation (=the level of the value of the saturation D), based on the brightness Y and the saturation D derived in Step S440 (Step S450). Specifically, it is derived as below. First, an upper limit Yh of the corrected brightness Y′ is derived from the brightness Y by Equation (3) described below. Next, the corrected brightness Y′ is derived from the saturation D, the brightness Y, and the upper limit Yh by Equation (4) described below. Here, the upper limit Yh is an integer of the values 191 to 255, and the corrected brightness Y′ is an integer of the values 0 to 255. If the values derived from Equations (3) and (4) are not integers, appropriate rounding processing is performed. FIG. 9 illustrates an explanatory diagram showing a state of deriving the corrected brightness Y′ in Step S450. In FIG. 9, the horizontal axis represents the value of the brightness Y derived in Step S440, and the vertical axis represents the value of the corrected brightness Y′. The corrected brightness Y′ is derived as a value equal to or greater than the brightness Y and equal to or less than the upper limit Yh. Further, the corrected brightness Y′ is the same value as the upper limit Yh when the saturation D is the value 255, is the same value as the brightness Y when the saturation D is the value 0, and the correction width (=corrected brightness Y′−brightness Y) is made to be great in proportion to the value of the saturation D within a range from the brightness Y to the upper limit Yh. For example, if the brightness Y is the value 55, the upper limit Yh is the value 205. The corrected brightness Y′ is derived, therefore, as a value between the brightness Y (the value 55) and the upper limit Yh (the value 205) corresponding to the level of the saturation D. For example, if the saturation D is the value 0, the corrected brightness Y′ is the value 55, if the saturation D is the value 100, the corrected brightness Y′ is the value 114, and if the saturation D is the value 255, the corrected brightness Y′ is the value 205. In so doing, when the brightness Y is compared for pixels of the same value, a corrected brightness Y′ in which the brightness Y is corrected to high resolution as the saturation D becomes higher. Once the corrected brightness Y′ is derived, the value of the derived corrected brightness Y′ is made to be the grayscale gradation values (8 bits) of the pixels at the coordinates (p, q) as is (Step S460). The processes of Steps S440 to S460 are to perform processing to generate converted image data that is the gradation values of RGB of the pixel at the coordinates (p, q) corrected to a high brightness Y corresponding to the level of the saturation D, and color converted to a gradation value of K, that is, a grayscale gradation value (8 bits).

Yh=255−(255−Y)/4 (3)

Y′=(D*Yh+(255−D)*Y)/255 (4)

Once the processes of Step S430 or Step S460 are performed, halftone processing of converting the post-color conversion grayscale gradation value of the pixel at the coordinates (p, q) from 8 bits to 2 bits each is executed (Step S470). This processing is performed similarly to the processing of Step S340 described above. That is, similarly to FIG. 6, the generation rate (level data) is derived from a generation rate derivation table illustrating the correspondence relationship between the grayscale gradation value of before performing halftone processing and the generation rate (%) of each dot type of large, medium, and small, and a value of 2 bits representing any state among large, medium, small, and none is derived from this level data and dither matrixes. Here, the generation rate derivation table and dither matrix for each dot type used in Step S470 are set in order for the deepness of a region formed with dots to appear deep (closer to black), corresponding to how small the grayscale gradation values (8 bits) are, to a person observing the region. Further, with regard to the pixels other than the edge pixels, since correction of the brightness as described in Step S450 has been performed, even if the gradation values of RGB of the original pixel are the same, compared to the edge pixels, the deepness of the pixels of the edge pixels tends to appear paler (closer to white).

Once the halftone processing of Step S470 is performed, the controller 40 increments the pointer q by a value 1 (Step S480), and determines whether or not the pointer q has exceeded the value ymax (Step S490). Further, if a negative determination is made, the process proceeds to Step S410, and repeats the processes of Steps S410 to S490 until affirmative determination is made in Step S490. In so doing, sequential processing is performed on pixels from the coordinates (p, 1) to (p, ymax). Further, if an affirmative determination is made in Step S490, the grayscale color conversion processing is ended.

Returning to the draft printing routine of FIG. 3, when the CMYK color conversion processing of Step S160 or the grayscale color conversion processing of Step S170 is ended, the controller 40 increments the pointer p by a value 1 (Step S180), and determines whether or not the halftone processing of either Step S340 or Step S470 has been performed and there are enough unprinted pixels for one pass (Step S190). For example, in a case where there are 90 nozzles each of the nozzles 32C, M, Y, and K1, and there are 180 nozzles K2 of the printing head 28, since the number of pixels printable by one pass is 270 vertically (=90+180), affirmative determination is made when halftone processing has been performed and there are 270 pixels vertically×ymax pixels horizontally of unprinted pixels. Further, if a negative determination is made, the process proceeds to Step S150, and repeats the processes of Steps S150 to S190 until affirmative determination is made in Step S190. Further, if an affirmative determination is made in Step S190, data (coordinates of pixels and gradation values of post-color conversion (2 bits)) of pixels for one pass on which halftone processing has been performed in Step S340 or Step S470 and that is unprinted is transmitted to the printer unit 20 along with the print command (Step S200). In addition, the ASIC 21 of the printer unit 20 in which the print command and the data of pixels for one pass are input controls the carriage motor 23 and the transporting roller 29, adjusts the positions of a print head 28 and the paper S, and while moving the print head 25 in the main scanning direction, printing of an image is performed on the paper S by applying a voltage to the piezoelectric elements of the printer mechanism 22. In so doing, an image based on the gradation values of pixels for one pass is formed on the paper S. Further, once the processing of Step S200 is performed, the controller 40 determines whether or not the pointer p has exceeded the value xmax (Step S210). Further, if a negative determination is made, the process proceeds to Step S150, and repeats the processes of Steps S150 to S210 until affirmative determination is made in Step S210. In so doing, printing is sequentially performed one pass at a time. Further, if an affirmative determination is made in Step S210, the draft printing routine is ended.

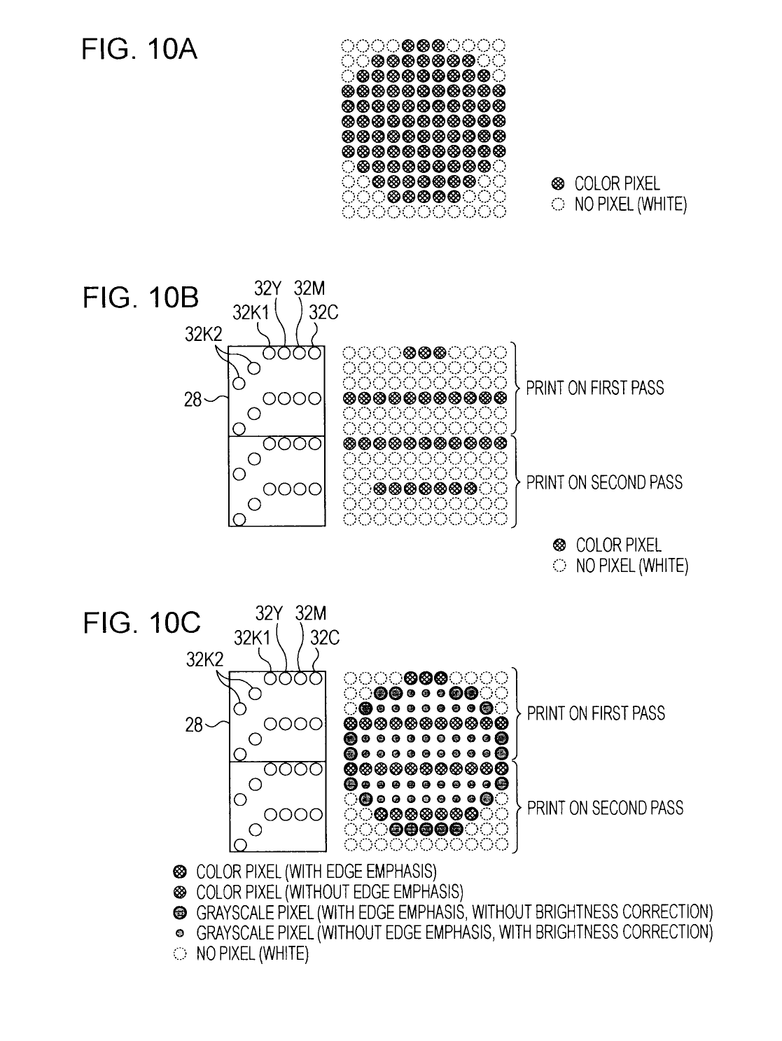

The state of performing printing by the draft printing routine described above will be described using FIG. 10. Here, for convenience of description, the color image data is composed of pixels in the form of a matrix of 12 pixels vertically×11 pixels horizontally, and the number of nozzles 32C, 32M, 32Y, and 32K1, and the number of nozzles 32K2 of the printing head 28, are respectively 2 and 4. FIG. 10A is an example of color image data of after performing the resolution conversion processing in Step S110. FIG. 10B is an example, as a comparative example, of a printed color image in a case when the draft mode printing of the past is performed by the printing head 28 on the above color image data. As shown in the drawings, since the resolution is low for the nozzles 32C, 32M, 32Y, and 32K1 that can form a color image, unless colored dots are formed in the gaps on the paper transporting direction of the colored dots formed during the first pass, the gaps between the dots become larger and the visibility of the image deteriorates. FIG. 10C is an example of a color image on which printing has been performed by the draft printing routine of the embodiment. As shown in the drawing, since a grayscale image is formed from the dots of the nozzles 32K2 in the gaps between the nozzles 32C, 32M, 32Y, and 32K1 when printing by one pass, the visibility of the image is improved. In addition, in the embodiment, with regard to the pixels other than the edge pixels out of the pixels forming the grayscale image by the nozzles 32K2, the grayscale gradation values are determined by the corrected brightness Y′ corrected in order for the brightness Y to be a high brightness corresponding to the level of the saturation D of the pixels. In so doing, color reproducibility for pixels other than the edge pixels can be improved. Further, with regard to the edge pixels, since edge emphasis processing is performed and correction of the brightness is not performed, deterioration in visibility of the edges of an image can be prevented. Here, in actual image formation, although both colored pixels and grayscale pixels are formed as large, medium, and small dots by halftone processing, in FIGS. 10B and 10C, only the pixels that tend to increase small dots (the print becomes pale) from performing correction of the brightness are shown as small dots.

Here, the correspondence relationship between the constituent elements of the embodiment and the constituent elements of the invention will be clarified. The controller 40 that obtains colored image data of a printing resolution by performing the resolution conversion processing of Step S120 of the embodiment corresponds to the color image data obtaining section of the invention, the controller 40 that performs the processes of Steps S150 and S170 corresponds to the converted image data generation section, the controller 40 that performs transmission of pixel data for one pass in Step S200 corresponds to the transmitting section, the controller 40 that performs the processing of Step S130 corresponds to the edge detection section, and the controller 40 that performs the processes of the Steps S320 and S420 corresponds to the edge emphasis section.

The ink jet printer 10 described in detail above is provided with the printing head 28, the carriage motor 23 that moves the printing head 28 in the main scanning direction that is substantially orthogonal to the transporting direction of the paper S, and the transporting roller 29 that moves the paper S in the transporting direction, and the controller 40 is connected via the bus 80 to the printer unit 20 that can form an image on the paper S by discharging ink from the printing head 28. In addition, the printing head 28 of the printer unit 20 includes the nozzle rows 30C, 30M, and 30Y that are the nozzles 32C, 32M, and 32Y that discharge CMY ink lined up in the transporting direction of the paper S at the first resolution, the nozzle row 30K1 that is the nozzles 32K1 that discharge K ink lined up in order to be aligned in positions with the nozzle rows 30C, 30M, and 30Y in the transporting direction at the first resolution, and the nozzle row 30K2 that is the nozzles 32K2 that discharge K ink lined up in order for the gaps of the nozzles 32K1 in the transporting direction to be divided into 3 equal parts. Further, the controller 40 obtains post-resolution conversion color image data composed of pixels in a matrix form that is a plurality of pixels at the second resolution that is three times the first resolution lined up in the vertical direction that corresponds to the transporting direction of the paper S, and a plurality of pixels lined up in the horizontal direction that corresponds to the main scanning direction. Next, out of each pixel of the color image data, the gradation values of the pixels other than the pixels arranged corresponding to the first resolution in the vertical direction are color converted to grayscale gradation values, and the data of the post-color conversion pixels is transmitted to the printer unit 20. In so doing, the data of the pixels to be transmitted to the printer unit 20 is pixels other than the pixels arranged corresponding to the first resolution in the vertical direction, that is, pixels corresponding to the positions of the nozzles 32K2 of the printer unit 20 converted into grayscale pixels. For this reason, when the printer unit 20 performs image formation in the draft mode, by discharging ink from the nozzles of the nozzle rows 30C, 30M, 30Y, and 30K1 while moving the printing head 28 once (one pass) in the main scanning direction, an image (color image) based on the gradation values of the pixels arranged corresponding to the first resolution in the vertical direction can be formed. Further, by discharging ink from the nozzles of the nozzle row 30K2, an image (grayscale image) based on the gradation values of the pixels other than the pixels arranged corresponding to the first resolution in the vertical direction can be formed. In so doing, since dots of the nozzles 32K2 are formed on portions that become gaps in the paper transporting direction of the dots formed by the nozzle rows 30C, 30M, 30Y, and 30K1 in the draft mode of the past, the visibility of the color image formed on the paper is improved. Here, since there is no need to form an image based on the gradation values of the pixels other than the pixels arranged corresponding to the first resolution can be formed by the ink of the nozzles 32C, 32M, 32Y, and 32K1, that is, there is no need for a movement such as to perform image formation for one pass by transporting the paper by only one third of the nozzle pitch of the nozzles 32C, 32M, 32Y, and 32K1, the speed of image formation does not differ from the draft mode of the past. In this manner, by the controller 40 of the embodiment executing the draft printing routine described above, image data that can improve the visibility of a color image in the draft mode can be provided to the printer unit 20.

In addition, since edge pixel detection is performed, color conversion to grayscale pixels is performed without performing correction of the brightness with regard to the edge pixels, and color conversion to grayscale pixels is performed by performing correction of the brightness to be a high brightness corresponding to the level of the saturation with regard to the pixels other than the edge pixels, the color reproducibility of the pixels other than the edge pixels can be improved while preventing deterioration in the visibility of the edge pixels. That is, if correction of the brightness is performed, whereas there is a case where, particularly with regard to the edge pixels corresponding to the edge portions of an image, visibility is reduced compared to a case where correction of the brightness is not performed, this can be prevented.

In addition, with regard to the edge pixels, since edge emphasis processing is performed, deterioration in the visibility of the edge pixels can be further prevented.

Here, needless to say, the invention is not limited to the embodiment described above, and may be realized by various embodiments within the technical range of the invention.

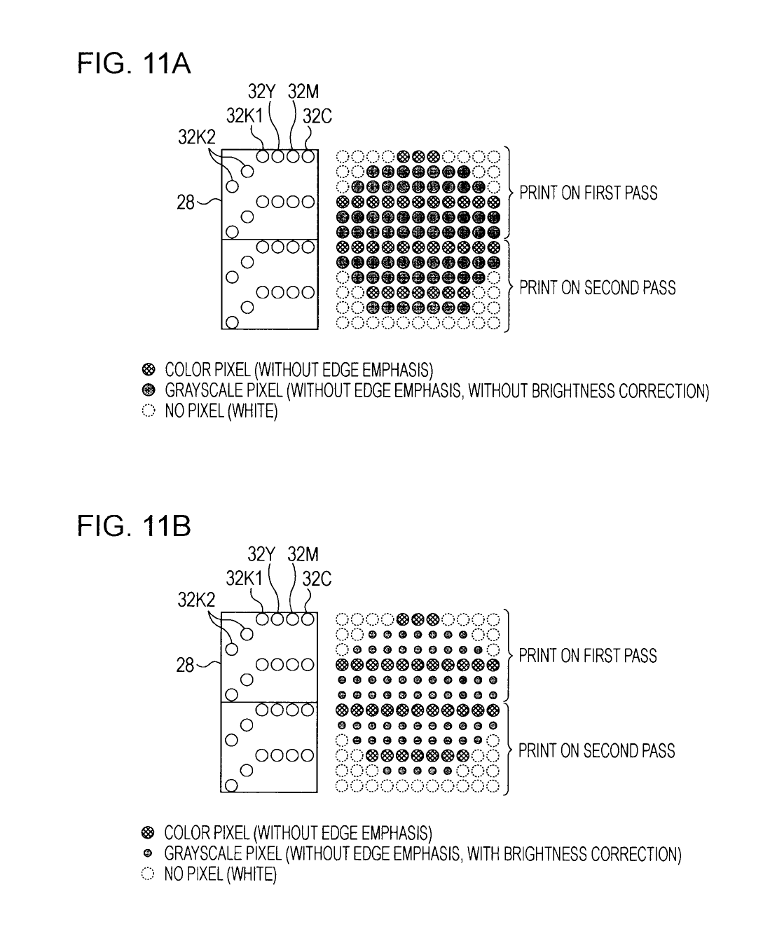

For example, although edge emphasis processing is performed with regard to the edge pixels in the embodiment described above, edge emphasis processing may be not performed. Further, although the brightness correction of Steps S440 to S460 is not performed on the edge pixels when performing the grayscale color conversion processing of FIG. 8, brightness correction may be not performed regardless of whether or not there are edge pixels, or brightness correction may be performed regardless of whether or not there are edge pixels. With regard to the color image data of FIG. 10A, an image printed in the draft mode in a case when brightness correction is not performed regardless of whether or not there are edge pixels is illustrated in FIG. 11A, and an image printed in the draft mode in a case when brightness correction is performed regardless of whether or not there are edge pixels is illustrated in FIG. 11B. Here, both FIGS. 11A and 11B are illustrated as a case when edge emphasis processing of the edge pixels is not performed.

Although the nozzles 32K2 are lined up in order for the gaps (length L) of the nozzles 32K1 of the nozzle row 30K1 in the transporting direction to be divided into 3 equal parts as in FIG. 2 in the embodiment described above, the invention is not limited thereto, and the nozzles 32K2 may be lined up in order for the gaps between the first achromatic nozzles in the transporting direction to be a (where a is an integer equal to or greater than 2) equal parts. Although in the embodiment, the printing head 28 discharges three types of chromatic ink from the nozzle rows 30C, 30M, and 30Y, it may be a printing head able to discharge four or more types of chromatic ink.

Although the image processing apparatus of aspects of the invention is described as the ink jet printer 10 that is provided with the controller 40 that executes the draft printing routine and the printer unit 20 that performs printing on the paper S in the embodiment above, it is not limited thereto. For example, the image processing apparatus of aspects of the invention may be a computer on which a printer driver that can execute the draft printing routine is installed. Even in this case, by connecting the computer with an ink jet printer by, for example, a USB connection, similar effects as those of the embodiment described above can be obtained.

Although color image data of a printing resolution is obtained by performing resolution conversion processing on color image data input in Step S110 in the embodiment described above, the color image data of the printing resolution recorded on the memory card MC from the start may be input.

What is claimed is:

1. An image processing apparatus connected to an image forming apparatus including a head that includes a chromatic nozzle row that is chromatic nozzles that discharge chromatic ink lined up in a paper transporting direction at a first resolution, a first achromatic nozzle row that is first achromatic nozzles that discharge achromatic ink lined up with the chromatic nozzle row in order for positions in the transporting direction to be aligned at the first resolution, and a second achromatic nozzle row that is second achromatic nozzles that discharge achromatic ink lined up in order for gaps between the first achromatic nozzles in the transporting direction to be equal parts of A (where A is an integer equal to or greater than 2), a head moving section that moves the head in a main scanning direction that is substantially orthogonal to the paper transporting direction, and a paper feeding section that moves the paper in the transporting direction, wherein an image is able to be formed on the paper by discharging the ink from the head, the image processing apparatus comprising:
a color image data obtaining section that lines up a plurality of pixels in the vertical direction that corresponds to the paper transporting direction at a second resolution that is the first resolution multiplied by A, while obtaining color image data composed of pixels in a matrix form that is a plurality of pixels lined up in the horizontal direction corresponding to the main scanning direction;
a converted image data generation section that generates converted image data where gradation values of pixels other than pixels that have been arranged corresponding to the first resolution in the vertical direction, out of each of the pixels of the color image data, are color converted to grayscale gradation values; and
a transmitting section that transmits the converted image data to the image forming apparatus.

2. The image processing apparatus according to claim 1, wherein the converted image data generation section derives the saturation and brightness of pixels from the gradation values of the pixels that are the subjects of the color conversion, corrects the brightness of the pixels that are the subjects of the color conversion to a high brightness corresponding to the level of the derived saturation, and makes the grayscale gradation values obtained by reflecting the post-correction brightness the gradation values of the post-color conversion pixels.

3. An image forming apparatus comprising:
a head including a chromatic nozzle row that is chromatic nozzles that discharge chromatic ink lined up in a paper transporting direction and an achromatic nozzle row that is achromatic nozzles that discharge achromatic ink lined up in the transporting direction at a first resolution that is higher than that of the chromatic nozzle row;
a head moving section that moves the head in a main scanning direction that is substantially orthogonal to the transporting direction;
a paper feeding section that moves the paper in the transporting direction;
an image data obtaining section that obtains color image data composed of a plurality of pixels; and
a forming section that forms an image on the paper by discharging the ink from the head,
wherein the forming section, as well as discharging the chromatic ink from the chromatic nozzle row based on the color image data, discharges the achromatic ink from the achromatic nozzle row based on unused pixels where the chromatic nozzle row did not discharge the chromatic ink out of the pixels of the color image data.

4. The image forming apparatus according to claim 3, further comprising:
a converted image data generation section,
wherein the converted image data generation section generates converted image data that is the gradation values of the unused pixels color converted to grayscale gradation values,
wherein the forming section discharges the achromatic ink from the achromatic nozzle row based on the converted image data.

5. The image forming apparatus according to claim 4, wherein the converted image data generation section derives the saturation and brightness of the pixels from the gradation values of the unused pixels, corrects the brightness of the unused pixels to a high brightness corresponding to the level of the derived saturation, and makes the grayscale gradation values obtained by reflecting the post-correction brightness the gradation values of the post-color conversion pixels.

6. The image forming apparatus according to claim 3, wherein
the chromatic nozzle row lines up the chromatic nozzles at a second resolution,
the achromatic nozzle row is composed of a first achromatic nozzle row and a second achromatic nozzle row,
the nozzles of the first achromatic nozzle row are lined up with the nozzles of the chromatic nozzle row in order for positions in the main scanning direction to be aligned, and
the nozzles of the second achromatic nozzle row are lined up in order for the achromatic nozzle row to be at the first resolution by filling the gaps between the nozzles in the transporting direction of the first achromatic nozzle row.

7. The image forming apparatus according to claim 3, further comprising:
a first printing mode; and
a second printing mode,
wherein the forming section uses, in a case of forming an image using the first printing mode, the achromatic nozzle row, while on the other hand, in a case of forming an image using the second printing mode, the forming section uses the chromatic nozzle row instead of the achromatic nozzle row.

8. The image forming apparatus according to claim 7, wherein
the first printing mode moves the paper in the transporting direction for every scan of the head in the main scanning direction for only the length of the achromatic nozzle row, and
in the second printing mode, the movement amount of the paper is smaller than in the first printing mode.

9. The image forming apparatus according to claim 5, further comprising:
an edge detection section that detects edge pixels corresponding to the edge portions of the color image data,
wherein the converted image data generation section makes, with regard to the edge pixels out of the unused pixels, the grayscale gradation values obtained by deriving the brightness of the pixels from the gradation values of the pixels that are the subjects of the color conversion and reflecting the derived brightness the gradation values of the post-color conversion pixels, and with regard to the pixels other than the edge pixels, the converted image data generation section makes the grayscale gradation values obtained by deriving the saturation and brightness of the pixels from the gradation values of the unused pixels, correcting the brightness of the pixels that are the subjects of the color conversion to a high brightness corresponding to the level of the derived saturation, and reflecting the post-correction brightness the gradation values of the post-color conversion pixels.

10. The image forming apparatus according to claim 9, further comprising:
an edge emphasis section that performs edge emphasis processing on edge pixels detected by the edge detection section out of the color image data,
wherein the converted image data generation section generates, out of the color image data on which the edge emphasis processing has been performed, converted image data that is the gradation values of the pixels other than the pixels arranged in correspondence with the first resolution in the vertical direction color converted to a grayscale gradation values, the converted image data generation section makes, out of the unused pixels, with regard to the edge pixels, the grayscale gradation values obtained by deriving the brightness of the pixels from the gradation values of the unused pixels and reflecting the derived brightness the gradation values of the post-color conversion pixels, and with regard to the pixels other than the edge pixels, makes the grayscale gradation values obtained by deriving the saturation and brightness of the pixels from the gradation values of the unused pixels, correcting the brightness of the unused pixels to a high brightness corresponding to the level of the derived saturation, and reflecting the post-correction brightness the gradation values of the post-color conversion pixels.

11. A computer-readable recording medium with a program stored to make any section of an image forming apparatus according to claim 1 function as an image processing apparatus.

12. A computer-readable recording medium with a program stored to make any section of an image forming apparatus according to claim 2 function as an image processing apparatus.

13. A computer-readable recording medium with a program stored to make any section of an image forming apparatus according to claim 3 function as an image processing apparatus.

14. A computer-readable recording medium with a program stored to make any section of an image forming apparatus according to claim 4 function as an image processing apparatus.

15. A computer-readable recording medium with a program stored to make any section of an image forming apparatus according to claim 5 function as an image processing apparatus.

16. A computer-readable recording medium with a program stored to make any section of an image forming apparatus according to claim 6 function as an image processing apparatus.

17. A computer-readable recording medium with a program stored to make any section of an image forming apparatus according to claim 7 function as an image processing apparatus.

18. A computer-readable recording medium with a program stored to make any section of an image forming apparatus according to claim 8 function as an image processing apparatus.

19. A computer-readable recording medium with a program stored to make any section of an image forming apparatus according to claim 9 function as an image processing apparatus.

20. A computer-readable recording medium with a program stored to make any section of an image forming apparatus according to claim 10 function as an image processing apparatus.
